(19) United States
(12) Patent Application Publication
(10) Pub. No.: US 2003/0000960 A1
(43) Pub. Date: Jan. 2, 2003

(54) Article for storing and dispensing multiple units of cosmetic product and related methods

(75) Inventors: Cynthia Cirlin, New York, NY (US); Julio Gans Russ, Westfield, NJ (US)

Correspondence Address: Julie Blackburn, Esq., Revlon Consumer Products Corporation, Law Dept., 625 Madison Avenue, New York, NY, 10022, US

(73) Assignee: Revlon Consumer Products Corporation, New York, NY

(21) Appl. No.: 10/225,064

(22) Filed: Aug. 21, 2002

Related U.S. Application Data
(63) Continuation of application No. 09/810,136, filed on Mar. 16, 2001.
(60) Provisional application No. 60/190,066, filed on Mar. 17, 2000.

(51) Int. Cl. A47F 1/04; G07F 11/16

(52) U.S. Cl. 221/303

(57) ABSTRACT

An article for storing and dispensing multiple units of cosmetic product comprising a plurality of units of cosmetic product, each unit comprised of a body portion with a first end and a second end, with the first end in the form of a solid cosmetic product for application to skin, nails, or hair, and the second end in the form of a hollow cavity of a size and shape to house the solid cosmetic product of the first end when the units are stacked in nested relationship; and an elongated hollow body for housing the units in slideable, stacked, nested relationship, the hollow body having a first open end for holding one of the plurality of units in position for use by the consumer, and enabling extraction of that unit from the hollow body after use; and a second open end for inputting the extracted unit into the hollow body to cause slideable movement of the stacked, nested units so that the next of the plurality of units is moved into position for use by the consumer in the first open end; as well as a method for storing and dispensing a plurality of cosmetic product units from said dispenser.

This application claims priority from provisional patent application serial No. 60/190,066, filed Mar. 17, 2000.

### TECHNICAL FIELD

The invention is in the field of articles for storing and dispensing multiple cosmetic compositions from a unitary source, and a method for dispensing such cosmetic compositions from the article for application skin, nails, or hair.

### BACKGROUND OF THE INVENTION

Women who wear makeup most often use a variety of differently colored cosmetics in their usual makeup routine. For example, most women who wear eyeshadow apply one color to the eyelid, a second color to the area above the eyelid, and sometimes third and fourth colors at the corner of the eyes or in other places. If the eyeshadow is in the pencil form the consumer must carry multiple pencils in her cosmetic bag. The same situation occurs with lipsticks, eyeliner pencils, foundations, and other cosmetics dispensed in the solid form. At some point, it becomes unwieldy to carry numerous pencils and compacts, so women tend to carry only the basic cosmetics in their cosmetic bags or purses. As a result, the woman on the go does not have the full palette of colors to make up.

Modern women desire small, compact, unitary, storage and dispensing articles for the variety of cosmetics used in the daily routine. Preferably, these storage and dispensing articles or devices will be capable of holding most, if not all, of the cosmetics used in the user's daily routine.

It is an object of the invention to provide a unitary storage and dispensing device for multiple cosmetic products applied to skin, hair, or nails.

It is a further object of the invention to provide a method for storing and dispensing multiple cosmetic compositions for application to skin, hair, or nails from a unitary source.

It is a further object of the invention to provide a unitary storage and dispensing device for multiple colors of solid cosmetic product such as lipstick, eyeshadow, foundation, eyeliner, and the like, such that the consumer may have a palette of colors at her fingertips.

### SUMMARY OF THE INVENTION

The invention is directed to an article for storing and dispensing multiple units of cosmetic product comprising, in combination:

(a) a plurality of units of cosmetic product, each unit comprised of a body portion with a first end and a second end, with said first end in the form of a cosmetic product for application to skin, nails, or hair, and the second end in the form of a hollow cavity of a size and shape to house the cosmetic product of the first end when the units are stacked in nested relationship;

(b) an elongated hollow body for housing said units in slideable, stacked, nested relationship, said hollow body having a first open end for holding one of the plurality of units in position for use by the consumer, and enabling extraction of that unit from the hollow body after use; and a second open end for inputting the extracted unit into the hollow body to cause slideable movement of the stacked, nested units so that the next of the plurality of units is moved into position for use by the consumer in the first open end.

The invention also comprises a method for storing and dispensing a plurality of cosmetic product units from a single dispenser comprising:

(a) preparing a plurality of units of cosmetic product, each unit comprised of a body portion with a first end and a second end, with said first end in the form of a cosmetic product for application to skin, nails, or hair, and the second end in the form of a hollow cavity of a size and shape to house the solid cosmetic product of the first end when the plurality of units are stacked in nested relationship;

(b) inserting the plurality of units in stacked, nested, relationship in a hollow elongated body having a first open end for holding one of the plurality of units in position for use by the consumer, and enabling extraction of that unit from the hollow body after use; and a second open end for inputting the extracted unit into the hollow body;

(c) extracting the unit from the first open end after use by the consumer and inputting the extracted unit into the second open end and causing slideable movement of the stacked, nested units so that the next of the plurality of units is moved into position for use by the consumer in the first open end.

### BRIEF DESCRIPTION OF THE DRAWINGS

FIG. 1: illustrates the article in accordance with the invention.

FIG. 2(a): illustrates an individual unit for the cosmetic product.

FIG. 2(b): is a tearaway view of the unit of FIG. 2(a).

FIG. 3: illustrates the elongated hollow body with the units removed.

FIGS. 4(a)-(d): illustrate how a single unit is extracted from the elongated hollow body and inserted into the top of the hollow body, and the slidable movement of the nested units.

FIG. 5: illustrates a cap that may be used as a cover for the article.

FIG. 6: illustrates the article with the cap in place.

FIG. 7: illustrates another embodiment of the invention where the article is in the shape of a pencil, such as for dispensing eye- and lipliner.

### DETAILED DESCRIPTION

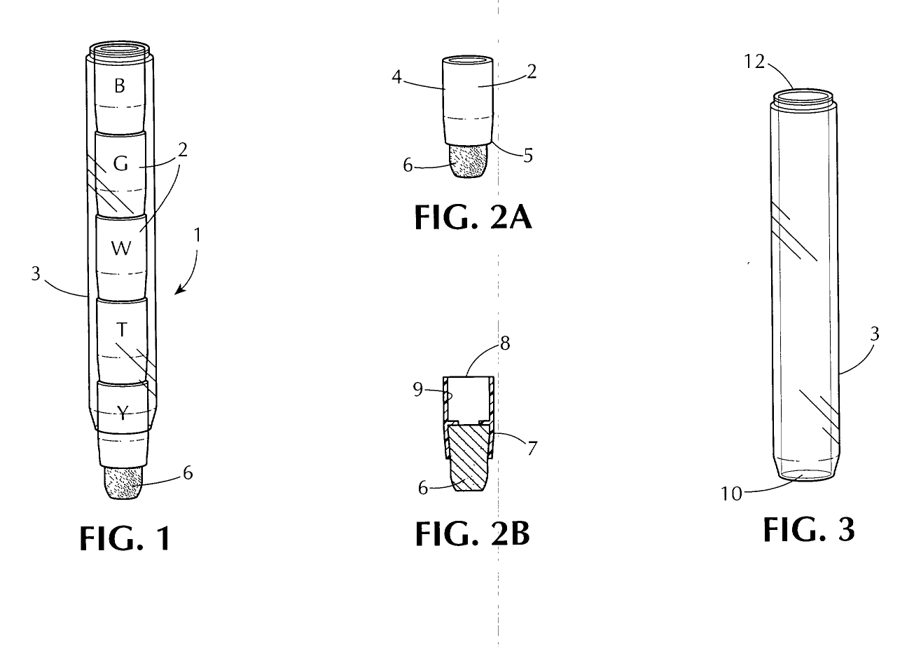

FIG. 1 illustrates one embodiment of the article or device 1 of the invention. The article comprises a plurality of units of cosmetic product 2 housed in an elongated hollow body 3. For illustrative purposes, each unit of cosmetic product 2 is marked with a letter which is meant to designate the color of the cosmetic product found within the unit. This marking of the units should not be construed to as a limitation of the claims in any way, as the units may be marked with indicia, or not marked as desired, and will still be within the scope of the invention.

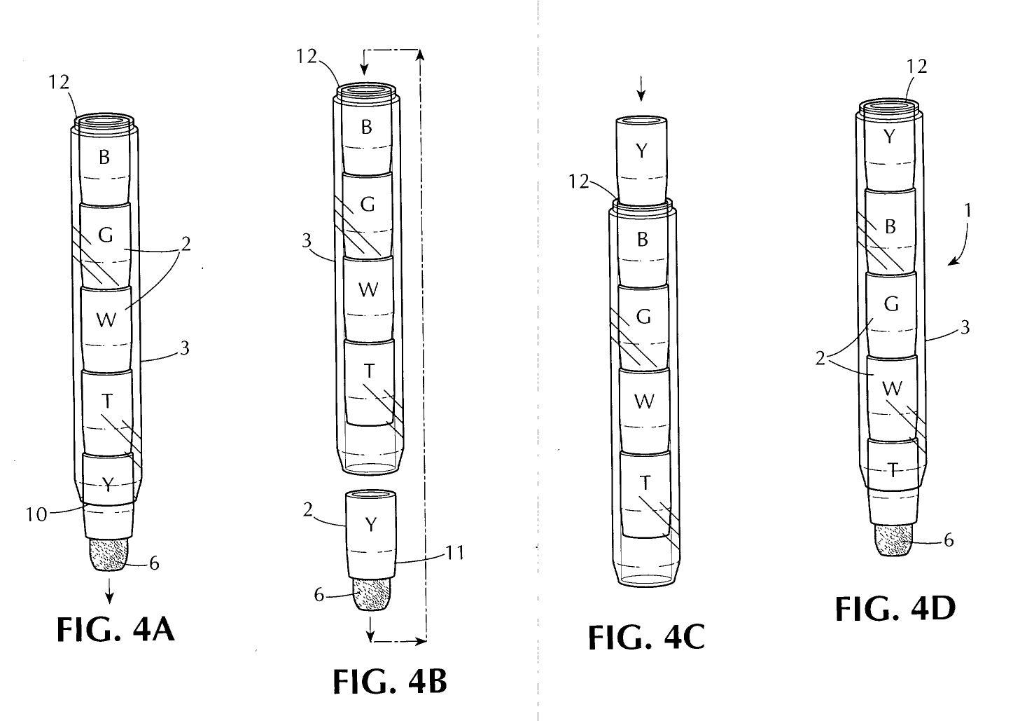

The units of cosmetic product 2 as depicted in FIG. 2, comprise a body portion 4 with a first end 5 in the form of a solid cosmetic product 6 for application to skin, hair, or nails. The cosmetic product may be in the form of eyeshadow, blush, lipstick, foundation, concealer, skin moisturizer, hair color, and the like. There is no limitation on the type of cosmetic product that may be incorporated into the first end 5 of the body portion 4, except that the cosmetic must be capable of being applied and dispensed from the body portion 4 and capable of storage in the elongated hollow body 3. Generally, the elongated hollow body 3 may have a circumference ranging from 0.1 to 1 inch. The hollow body 3 may have a circular, square, rectangular, or triangular cross-section, in addition to other cross-sectional shapes as well. The only limitation on the cross-sectional shape of the elongated hollow body 3 is that it must be of a cross-sectional shape that permits the units 2 to move through it in slidable relationship. It should also be mentioned that the cross-sectional shape of the hollow body and the units must be the same, otherwise the units will not move in proper, slidable, nested relationship through the elongated hollow body. Preferably, the cosmetic product 6 is in the form of a solid, self-supporting cosmetic such as a lipstick bullet, eyeshadow pencil nib, nail enamel bottle, eyeshadow stick, and so on. The cosmetic product 6 may be pre-molded and inserted into the first end 5 of the body portion 4, preferably in a cavity 7 in body portion 4 as depicted in FIG. 2(b). The cosmetic 6 may also be direct filled into the cavity 7 in body portion 4. By direct filling is meant that the cosmetic product 6, while in the molten state, is poured into the cavity 7 and allowed to harden. It is also possible to fill the cosmetic into a holder-type device which is then inserted into the body. The body portion 4 has a second end 8 in the form of a hollow cavity 9 which is of a size and shape sufficient to house the cosmetic product 6 of the first end 5 when the units are placed in a nested, stacking relationship as shown in the Figures. The units are capable of slidable motion within the hollow elongated body as illustrated in FIGS. 4(a)-(d). Generally, the units have a cross-sectional size that is slightly smaller than that of the elongated hollow body 3, such that the units are held tightly within the elongated hollow body 3 but yet capable of slidable movement within the elongated hollow body when they are held in nested relationship within.

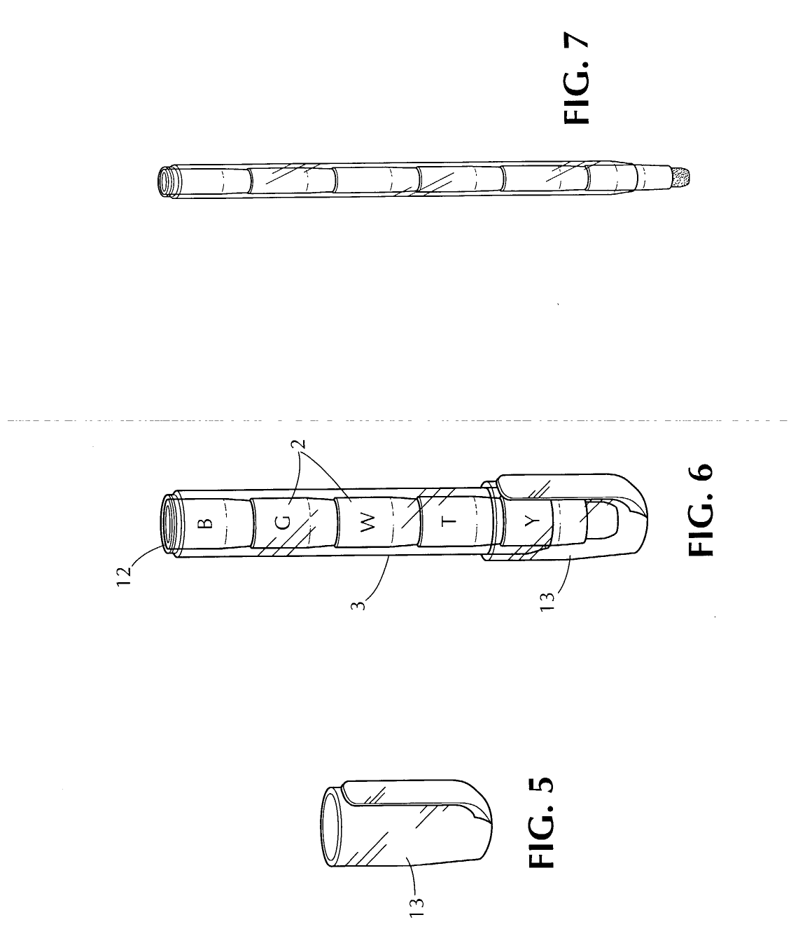

The elongated hollow body 3 has a first open end 10 for holding one of the plurality of units of cosmetic product 2 in a position for use by the consumer, and enabling extraction of that unit from the hollow body after the consumer has used it. The elongated body 3 also has an second open end 12 for inputting or inserting the unit 2 which is extracted from the first open end 10 of the elongated hollow body 3 after it has been used by the consumer. This is depicted in FIGS. 4(a)-(d). FIG. 4(a) illustrates the unit 2 when it is ready to be used by the consumer. The consumer will apply the cosmetic product 6 which is in the unit 2 marked “Y” to the face, eyes, or lips, or wherever it is desired. After the consumer has completed the application of the cosmetic product 6 in the unit marked “Y”, the consumer extracts the unit 2 from the hollow body 3 by gripping the lower portion 11 with the fingers and removing it from the hollow body 3 as shown in FIG. 4(b). The unit 2 marked “Y” is then inserted or input into the second open end 12 of the elongated hollow body 3. The unit 2 is inserted into the second open end 12, such that the cosmetic product 6 fits into the hollow cavity 9 of the unit 2 which is below it in nested relationship within the elongated hollow body 3. In FIG. 4(b), the unit marked “Y” is inserted into the elongated hollow body such that the cosmetic product 6 fits into the hollow cavity 9 of the unit marked “B”, in nested relationship. Then, the user simply exerts pressure on the unit marked “Y” and pushes the units “B”, “G”, “W” and “T” down the elongated hollow body 3 such that they slide down the body 3, and the unit marked “T”, then moves into position in the first open end 10 so that the cosmetic product in the unit 2 marked “T” can be used by the consumer. It should be noted that the hollow body 3 may be held upwardly or downwardly by the consumer, whichever is most comfortable. If held upwardly, the units 2 are extracted from the hollow body 3 by pulling upwardly. Similarly, when the extracted unit 2 is put back into the hollow body 3, it is inserted on the bottom and pushed upwardly to cause the units 2 to move in nested relationship and push the next unit 2 into position for use by the consumer. The elongated hollow body 3 containing the units 2 in nested relationship, can be used like a cosmetic pencil. If desired, the article 1 may have a removable cap 13 which is used to cover the unit 2 found in position in the first open end 10, as depicted in FIGS. 5 and 6.

FIG. 7 illustrates a similar embodiment of the invention where the elongated hollow body is slightly smaller in diameter, somewhat along the lines of a standard writing pen or pencil, which is particularly suitable for dispensing cosmetics such as eyeliner or lipliner.

Preferably the elongated hollow body is of a length sufficient to permit housing three to eight units 2 in slidable, nested relationship within. The invention also comprises a method for storing and dispensing a plurality of cosmetic product units from a single dispenser comprising:

(a) preparing a plurality of units of cosmetic product, each unit comprised of a body portion with a first end and a second end, with said first end in the form of a solid cosmetic product for application to skin, nails, or hair, and the second end in the form of a hollow cavity of a size and shape to house the solid cosmetic product of the first end when the plurality of units are stacked in nested relationship;

(b) inserting the plurality of units in stacked, nested, relationship in a hollow elongated body having a first open end for holding one of the plurality of units in position for use by the consumer, and enabling extraction of that unit from the hollow body after use; and a second open end for inputting the extracted unit into the hollow body;

(c) extracting the unit from the first open end after use by the consumer and inputting the extracted unit into the second open end and causing slideable movement of the stacked, nested units so that the next of the plurality of units is moved into position for use by the consumer in the first open end.

The article and method of the invention enables a single unitary source for storing and dispensing cosmetic products to be used by the consumer.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. An article for storing and dispensing multiple units of cosmetic product comprising, in combination:
(a) a plurality of units of cosmetic product, each unit comprised of a body portion with a first end and a second end, with said first end in the form of a cosmetic product for application to skin, nails, or hair, and the second end in the form of a hollow cavity of a size and shape to house the solid cosmetic product of the first end when the units are stacked in nested relationship;
(b) an elongated hollow body for housing said units in slideable, stacked, nested relationship, said hollow body having a first open end for holding one of the plurality of units in position for use by the consumer, and enabling extraction of that unit from the hollow body after use; and a second open end for inputting the extracted unit into the hollow body to cause slideable movement of the stacked, nested units so that the next of the plurality of units is moved into position for use by the consumer in the first open end.

2. The article of claim 1 wherein the solid cosmetic product is a solid cosmetic product formed in the shape of a bullet.

3. The article of claim 1 wherein the solid cosmetic product is pre-molded in the desired shape and inserted into the cavity.

4. The article of claim 1 wherein the cosmetic product is direct filled into the cavity.

5. The article of claim 1 wherein the cosmetic product is selected from lipstick, eyeshadow, eyeliner, concealer, blush, or foundation.

6. The article of claim 1 wherein the hollow body and the units are cylindrical.

7. The article of claim 1 wherein the hollow body and the units are square or rectangular in cross section.

8. The article of claim 1 wherein the hollow body houses three to eight units of cosmetic product.

9. The article of claim 6 wherein the hollow body has a circumference of about 0.1-1 inch.

10. The article of claim 1 wherein the hollow body has a length of about four to eight inches.

11. A method for storing and dispensing a plurality of cosmetic product units from a single dispenser comprising:
(a) preparing a plurality of units of cosmetic product, each unit comprised of a body portion with a first end and a second end, with said first end in the form of a solid cosmetic product for application to skin, nails, or hair, and the second end in the form of a hollow cavity of a size and shape to house the solid cosmetic product of the first end when the plurality of units are stacked in nested relationship;
(b) inserting the plurality of units in stacked, nested, relationship in a hollow elongated body having a first open end for holding one of the plurality of units in position for use by the consumer, and enabling extraction of that unit from the hollow body after use; and a second open end for inputting the extracted unit into the hollow body;
(c) extracting the unit from the first open end after use by the consumer and inputting the extracted unit into the second open end and causing slideable movement of the stacked, nested units so that the next of the plurality of units is moved into position for use by the consumer in the first open end.
